(19) United States
(12) Patent Application Publication
(10) Pub. No.: US 2011/0033755 A1
(43) Pub. Date: Feb. 10, 2011

(54) PROTECTED LITHIUM METAL ELECTRODES FOR RECHARGEABLE BATTERIES

(75) Inventors: Hany Basam Eitouni, Oakland, CA (US); Mohit Singh, Berkeley, CA (US); Nitash Pervez Balsara, El Cerrito, CA (US); William Hudson, Berkeley, CA (US); Ilan R. Gur, San Francisco, CA (US)

Correspondence Address: SEEO, INC., 626 BANCORFT WAY, SUITE 3B, BERKELEY, CA, 94710, US

(73) Assignee: Seeo, Inc, Berkeley, CA (US)

(21) Appl. No.: 12/988,474

(22) PCT Filed: Apr. 21, 2009
(86) PCT No.: PCT/US09/41180

§ 371 Date: Oct. 18, 2010

Related U.S. Application Data
(60) Provisional application No. 61/046,685, filed on Apr. 21, 2008.

(51) Int. Cl. H01M 10/052; H01M 4/40; H01M 10/0565; H01M 10/056; H01M 4/04; B05D 7/00; B29C 47/06

(52) U.S. Cl. 429/310; 429/231.95; 429/317; 429/314; 429/313; 429/315; 429/306; 429/316; 429/231.8; 429/226; 429/229; 427/77; 427/486; 156/244.11

(57) ABSTRACT

It has long been recognized that replacing the Li intercalated graphitic anode with a lithium foil can dramatically improve energy density due to the dramatically higher capacity of metallic lithium. However, lithium foil is not electrochemically stable in the presence of typical lithium ion battery electrolytes and thus a simple replacement of graphitic anodes with lithium foils is not possible. It was found that diblock or triblock polymers that provide both ionic conduction and structural support can be used as a stable passivating layer on a lithium foil. This passivation scheme results in improved manufacture processing for batteries that use Li electrodes and in improved safety for lithium batteries during use.

### CROSS REFERENCE TO RELATED APPLICATIONS

This application claims priority to U.S. Patent Provisional Application 61/046,685, filed Apr. 21, 2008, which is incorporated by reference herein.

Examples of solid nanostructured block copolymer electrolyte systems referenced to by this application are disclosed in various of Applicant's other applications, including International Application No. PCT/US09/31356, filed Jan. 16, 2009 entitled “Gel Polymer Electrolytes for Batteries” and U.S. patent application Ser. No. 12/271,829, filed Nov. 14, 2008 entitled “A Solid Electrolyte Material Manufacturable by Conventional Polymer Processing Methods,” the entire contents of both of which are incorporated by reference herein.

### BACKGROUND OF THE INVENTION

### Field of the Invention

This invention relates generally to battery electrodes, and, more specifically, to lithium metal electrodes that can be used safely in batteries that have either solid or liquid electrolytes.

The specific energy achievable in current ion lithium batteries is about 200 Wh/kg, when the weights of the electrodes, electrolyte, current collectors, and packaging are all taken into account. Secondary lithium ion batteries use lithium intercalated graphite anodes predominantly. It is well known that replacing such anodes with simple lithium metal foils can lead to a substantial increase in energy density to values as high as 300 Wh/kg or more. However, manufacturing safe lithium metal batteries in a cost-effective manner has proven to be very difficult.

The development of secondary batteries employing lithium metal as the negative electrode has been plagued with safety problems. As the battery is cycled, lithium that is deposited during charging tends to form dendrites extending out from the negative electrode into the adjacent separator or solid electrolyte. The dendrites can grow through the separator or electrolyte and short out to the positive electrode or they can react with the electrolyte, causing the battery to overheat. The melting point of lithium is 180° C. or lower, depending on the amount of impurities in the lithium, and the dendrites can melt easily. Molten lithium is violently reactive, especially with solvent-based electrolytes. Such reactions are highly exothermic and the heat generated can easily lead to catastrophic or explosive failure of the battery.

What is needed is a way to use lithium metal foils as battery anodes without suffering the drawbacks of volatility and high manufacturing expense.

### BRIEF DESCRIPTION OF THE DRAWINGS

The foregoing aspects and others will be readily appreciated by the skilled artisan from the following description of illustrative embodiments when read in conjunction with the accompanying drawings. The drawings are schematic only and are not intended to convey any information about the relative or absolute sizes of the various elements shown therein. The figures are not drawn to scale.

FIG. 1 is a schematic drawing that shows the main features of a conventional Li ion or Li metal battery.

FIG. 2 is a schematic drawing that shows a new lithium metal electrode assembly according to an embodiment of the invention.

FIG. 3 is a plot that shows heat flow as a function of temperature for lithium metal alone, lithium metal in contact with a commonly-used liquid electrolyte, and lithium metal in contact with a SEEO block copolymer electrolyte, indicating the surprising stability of the SEEO electrolyte

FIG. 4 is a schematic drawing that shows a new lithium metal battery cell according to an embodiment of the invention.

FIG. 5 is a schematic drawing that shows a new back-to-back lithium metal battery according to an embodiment of the invention.

FIG. 6 is a schematic drawing that shows a new back-to-back lithium metal battery according to another embodiment of the invention.

FIG. 7 is a schematic drawing of a diblock polymer and a domain structure it can form, according to an embodiment of the invention.

FIG. 8 is a schematic drawing of a triblock polymer and a domain structure it can form, according to an embodiment of the invention.

FIG. 9 is a schematic drawing of a triblock polymer and a domain structure it can form, according to another embodiment of the invention.

### DETAILED DESCRIPTION

The preferred embodiments are illustrated in the context of lithium metal electrodes in batteries. The skilled artisan will readily appreciate, however, that the materials and methods disclosed herein will have application in a number of other electrical devices where lithium metal as an ion source is desirable, particularly where stability and safety are important.

These and other objects and advantages of the present invention will become more fully apparent from the following description taken in conjunction with the accompanying drawings.

In this disclosure, the terms “negative electrode” and “anode” are both used to mean “negative electrode”. Likewise, the terms “positive electrode” and “cathode” are both used to mean “positive electrode”.

It is to be understood that when the terms “lithium metal” or “lithium foil” are used herein with respect to negative electrodes, they are meant to include both pure lithium metal and lithium-rich metal alloys as are known in the art. Examples of lithium rich metal alloys suitable for use as anodes include Li—Al, Li—Si, Li—Sn, Li—Hg, Li—Zn, Li—Pb, Li—C or any other Li-metal alloy suitable for use in lithium metal batteries. Other negative electrode materials that can be used in the embodiments of the invention include materials in which lithium can intercalate, such as graphite. Many embodiments described herein are directed to batteries with solid polymer electrolytes, which serve the functions of both electrolyte and separator. As is well known in the art, batteries with liquid electrolytes use an inactive separator that is distinct from the liquid electrolyte and generally cannot be used safely with lithium metal anodes in secondary batteries.

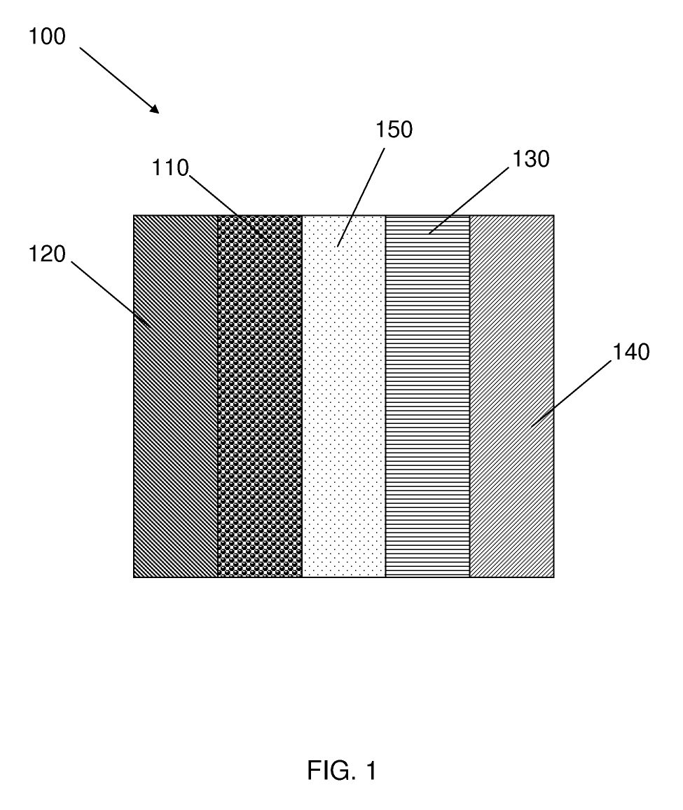

FIG. 1 is a schematic drawing that can be used to describe the main features of a conventional Li ion battery 100. The battery 100 has an anode 110 adjacent a current collector 120, a cathode 130 adjacent a current collector 140, and a separator 150 between the anode 110 and the cathode 130. The anode 110 is made of particles of graphite intercalated with lithium, which have been combined with particles of carbon and a binder. The anode 110 has very little mechanical strength and cannot be handled as a free-standing film. Often the anode 110 is formed onto the current collector 120 which is made of a metal such as copper and has sufficient strength to support the anode film 110 throughout manufacturing. The current collector 120 also provides a path by which (electronic) current can leave or enter the battery. Similarly, the cathode 130 is made of particles of a material that can receive Li ions, carbon particles, and a binder. The cathode 130 is formed onto the current collector 140 which is made of a metal such as aluminum in order to have sufficient strength to withstand manufacturing processes. The current collector 140 also provides a path by which (electronic) current can enter or leave the battery. A liquid electrolyte is added to fill spaces in the separator 150, the porous anode 110 and the porous cathode 130. Thus the liquid electrolyte provides a path for ionic conduction through the separator 150 between the anode 110 and the cathode 130.

The thickness of each of the current collectors 120, 140 is generally in a range of about 10-30 μm. Together the current collectors 120, 140 contribute about 10-20% to the overall weight of the battery 100. The thickness of the current collectors 120, 140 is chosen to give the anode film 110 and the cathode film 130 sufficient support. If supporting the electrodes were not a consideration, thinner current collectors 120, 140 could be used without compromising their current carrying function. Thinner current collectors 120, 140 could, of course, result in a battery with less weight without compromising performance.

It has long been recognized that replacing the Li intercalated graphitic anode with a lithium foil can dramatically improve energy density due to the dramatically higher capacity of metallic lithium. However, lithium foil is not electrochemically stable in the presence of typical lithium ion battery liquid electrolytes and thus a simple replacement of graphitic anodes with lithium foils is not possible. It was found that polyethyleneoxide (PEO), a solid polymer, mixed with a lithium salt such as Li[N(SO₂CF₃)₂], forms a stable passivating layer when contacted with a lithium foil. Unfortunately PEO-based polymers exhibited other limitations that have prevented their use in the successful creation of a lithium metal battery.

FIG. 1 is a schematic drawing that can also be used to describe the main features of a Li metal battery 100. The battery 100 has an anode 110 adjacent an optional current collector 120, a cathode 130 adjacent a current collector 140, and a solid polymer electrolyte 150 between the anode 110 and the cathode 130. The anode 110 is a lithium or lithium-rich alloy foil. The anode 110 may be in electronic contact with the optional current collector 120 which can be made of a metal such as copper. The optional current collector 120 can provide a path by which (electronic) current can leave or enter the battery. If the optional current collector 120 is not used, the lithium anode 110 itself can provide a path by which current can leave or enter the battery. The cathode 130 is made of particles of a material that can receive Li ions, carbon particles, a solid electrolyte (e.g., the same as the solid electrolyte 150), and an optional binder. In some arrangements, the solid electrolyte can serve the functions of both electrolyte and binder in the cathode. The cathode 130 is formed onto the current collector 140 which is made of a metal such as aluminum in order to have sufficient strength to withstand manufacturing processes. The current collector 140 also provides a path by which (electronic) current can enter or leave the battery. A battery that has only one electrochemically inactive current collector offers a substantial savings in weight as compared with a battery that has two such current collectors.

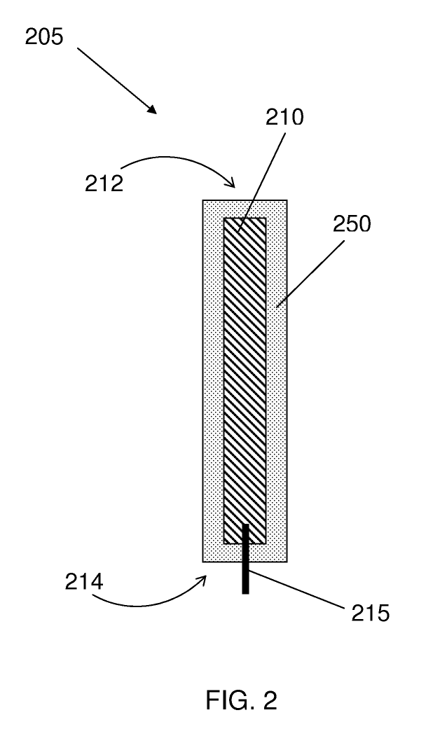

FIG. 2 is a schematic drawing that shows a new lithium metal electrode assembly 205 according to an embodiment of the invention. A lithium metal anode 210 is a thin lithium or lithium-rich alloy foil between about 1 and 40 μm thick. Such an anode 210 is also electronically conductive and can be used without a current collector. The anode 210 may not have sufficient mechanical strength to undergo processing to make a battery. The anode 210 is enclosed in a nanostructured block copolymer electrolyte 250 (also called SEEO electrolyte) to create an electrode assembly 205. In one arrangement (not visible in the figure), the anode 210 is at least partially coated with inorganic salts such as AlF₃ or BF₃. In one arrangement, the anode 210 is fully contained within the nanostructured block copolymer electrolyte 250, as shown in FIG. 2. Electrical contact to the anode 210 can be made via an electronically conducting material lead 215 (e.g., copper wire) in electronic communication with the anode 210 though the nanostructured block copolymer electrolyte 250. In another arrangement (not shown), one or both of electrode assembly ends 212, 214 is at least partially free of the nanostructured block copolymer electrolyte 250, and there is a very small region of exposed lithium or lithium alloy 210 to which a lead can be attached. Once the lithium or lithium alloy foil 210 is enclosed within the nanostructured block copolymer electrolyte 250, it is easier to handle and to process. Lithium metal, by itself, is soft and tacky, making it difficult to handle in manufacturing processes. But, if the lithium can be encapsulated, for example, in a flexible material, it is possible to make long sheets or tapes of the enclosed Li metal and roll it onto spools. Such an arrangement lends itself easily to automated manufacturing processes, which would not be possible without encapsulation. In one example, the nanostructured block copolymer electrolyte 250 is a polystyrene-polyethyleneoxide-polystyrene (PS-PEO-PS) triblock copolymer. Surprisingly, such an electrolyte 250 is chemically stable against lithium and lithium-rich alloys. Thus the electrode assembly 200 is also chemically stable and has sufficient mechanical strength to be handled easily. Such an assembly 200 can be used with an appropriate electrolyte and cathode to manufacture a battery, as is known in the art.

The inventive electrode assembly 205 also eliminates a major safety risk associated with previous lithium metal batteries. If a battery overheats to a temperature where lithium 210 begins to melt and become unstable, the surrounding nanostructured block copolymer electrolyte 250 maintains its stability, does not melt and can prevent the lithium from getting out of the encapsulation, thus preventing a runaway reaction and catastrophic failure.

The electrode assembly 205 can be made in a variety of ways. First, a lithium or lithium alloy foil with desired dimensions is provided. In some arrangements, the foil can be pre-coated with an inorganic salt(s) such as AlF₃ or BF₃. In one embodiment of the invention, the assembly 205 is formed using a coater. A solution of block copolymer electrolyte is applied to a set of rollers on the coater. The foil is run through the rollers, receives a coating of the block copolymer electrolyte, and is thus enclosed within the electrolyte. In another embodiment of the invention, a static charge is applied to the foil. Particles of block copolymer electrolyte are sprayed onto the foil. The foil coated with electrolyte particles is annealed, causing the particles to coalesce into a film, thus enclosing the foil within the electrolyte. In yet another embodiment of the invention, the assembly is formed using an extruder. Two layers of block copolymer electrolyte are applied to a foil—one layer on each side. The layers can be planar, they can be long beads, or they can have any other form known to be useful in extrusion processes. The foil with the block copolymer electrolyte on either side is fed into an extruder. The extruder presses against the layers, ensuring that the block copolymer electrolyte spreads over the foil and encloses it. In one arrangement, electronically-conductive leads 215 can be applied to the foil before foil is coated with electrolyte. In another arrangement, the lead(s) 215 can be inserted through the electrolyte 250 to make contact with the electrode 210 after the assembly 205 is formed.

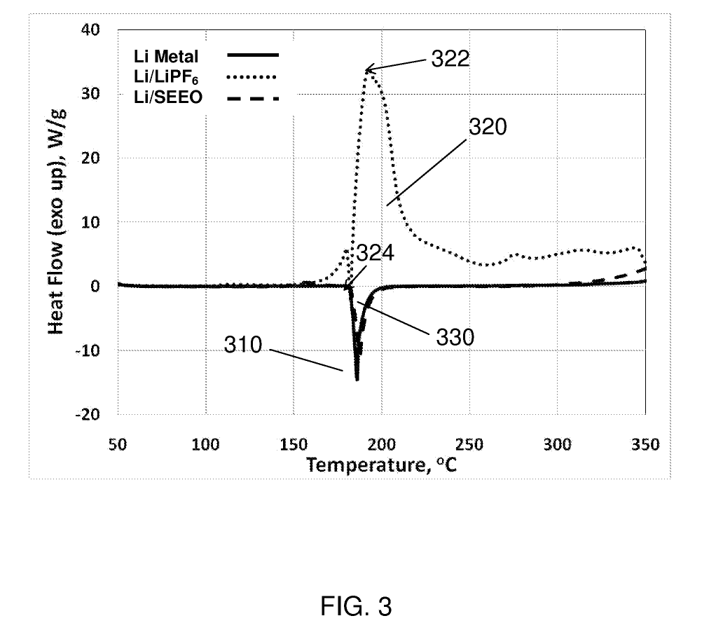

FIG. 3 is a plot that shows heat flow in watts/gram as a function of temperature for lithium metal alone (solid line) 310, high-surface-area lithium metal in contact with a commonly-used liquid electrolyte, LiPF₆, (dotted line) 320, and high-surface-area lithium metal in contact with a SEEO block copolymer electrolyte (dashed line) 330 that contains polyethylene oxide and polystyrene. The curve 310 shows that as the lithium metal reaches its melting point (˜180° C.), it begins to melt, absorbing heat without an increase in temperature. Once melting has occurred, the molten lithium is stable up to 300° C. or so, when there is an indication of the beginning of a change. The curve 320, on the other hand, shows the beginning of an exothermic reaction at around 160° C. The exothermic reaction continues through a most energetic point at 322, and continues reacting through 350° C. where the data collection ended. There is a dip 324 in the curve 320 where the endothermic lithium metal curve 310 and the exothermic lithium/LiPF₆ curve 320 add together. The curve 330 for the high-surface-area lithium in contact with SEEO electrolyte has substantial overlap with the curve 310 for the lithium metal alone, indicating that the SEEO electrolyte in contact with the high-surface-area lithium metal is essentially stable throughout this temperature range. This is a surprising result as lithium metal is known to be very reactive with most currently-used electrolytes, especially at these elevated temperatures.

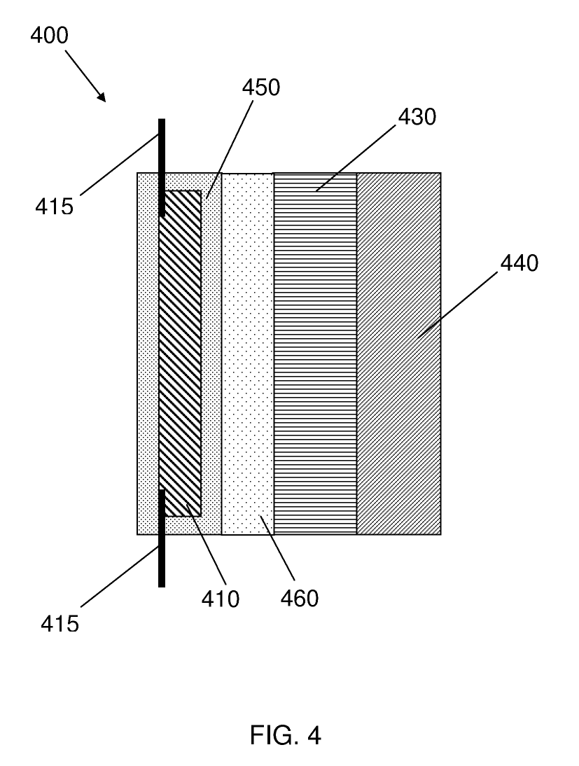

FIG. 4 is a schematic drawing that shows a portion of a battery cell 400 according to an embodiment of the invention. The battery 400 has a lithium metal anode 410 in electronic communication with a lead or leads 415 that provide(s) a path by which electronic current can leave or enter the anode 410. In one arrangement, the anode 410 is a thin lithium foil between about 1 and 40 μm thick. The anode 410 is enclosed within a nanostructured block copolymer electrolyte layer 450. In one example, the nanostructured block copolymer electrolyte 450 is a polystyrene-polyethyleneoxide-polystyrene (PS-PEO-PS) triblock copolymer doped with a lithium salt. The PEO block provides ion conducting channels, and the PS block adds mechanical integrity. The PS-PEO-PS/salt mixture serves also to ensure that even if the lithium metal becomes unstable or melts, no catastrophic battery failure can occur. In one arrangement (not visible in the figure), the anode foil 410 is at least partially coated with inorganic salts such as AlF₃ or BF₃.

There is an optional second electrolyte layer 460 adjacent the nanostructured block copolymer electrolyte 450. In one example, polysiloxane is used as the second polymer electrolyte 460. The second electrolyte layer 460 can be a very useful feature. Polymers that work well to perform useful structural, conductive, and safety functions for the lithium metal anode 410, such as the nanostructured block copolymer electrolyte 450, may not be optimized to interact with cathode 430. Multi-layered 450, 460 polymer electrolytes, optimized for specific roles within the battery, can be employed easily in the present inventive design, as virtually all polymers are sparingly soluble in one another. In one arrangement, the polymer electrolyte 450 is optimized to support and to stabilize the anode 410 and the second electrolyte layer 460 is a polymer optimized to interact with the cathode 430, that is, both to be incorporated into the cathode and to provide ionic conduction between the polymer electrolyte 450 and the cathode 430. In another arrangement, the cathode 430 incorporates a different polymer material than either the polymer electrolyte 450 or the second electrolyte layer 460. In arrangements where the optional second electrolyte layer 460 is not used, the electrolyte 450 can be adjacent the cathode 430.

When only liquid electrolytes are used in a battery, it is not possible to use multi-layered electrolytes because most electrolyte liquids are miscible in one another and the liquid layers would mix together. In one embodiment of the present invention, a separator and a liquid electrolyte that neither interacts with nor is miscible with the nanostructured block copolymer electrolyte 450 can be used as both the second electrolyte layer 460 (with a separator) and for permeating the cathode 430. There is a current collector 440 associated with the cathode 430. Although FIG. 4 suggests that the current collector 440 is as thick as the cathode 430, this is only one possible arrangement. In another arrangement, the current collector 440 is much thinner than the cathode 430. The current collector layer 440 can be continuous or non-continuous. The current collector layer 440 can have the form of a mesh, grid, or perforated film

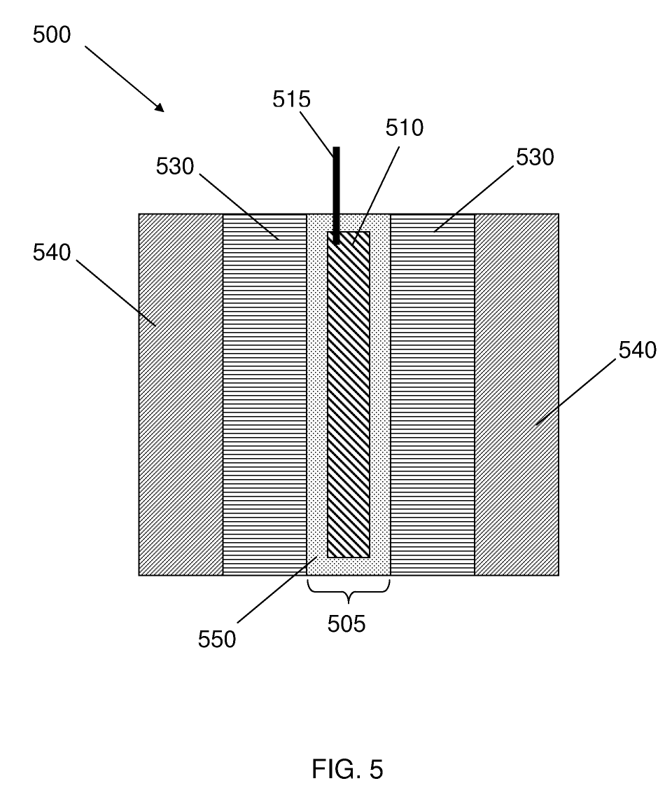

FIG. 5 is a schematic drawing that shows a portion of a new back-to-back lithium metal battery 500 according to an embodiment of the invention. The battery 500 has a lithium metal or metal alloy anode 510 that also serves as its own current collector and can make connections to a circuit (not shown) outside the battery 500 through one or more (not shown) lead(s) 515. The lead 515 provides a path for electronic conduction between the anode 510 and an external circuit. In one arrangement, the anode 510 is a thin lithium foil about 50 μm thick. In other arrangements, the anode 510 is a thin lithium foil between about 1 and 50 μm thick. The anode 510 may not have sufficient mechanical strength to undergo processing to make the battery 500. The anode 510 is enclosed within a nanostructured block copolymer electrolyte 550 to create an anode assembly 505. The lithium foil 510 enclosed within the nanostructured block copolymer electrolyte 550 is easier to handle than the foil 510 alone and can undergo processing more easily. There are conventional cathodes 530 on each side of the nanostructured block copolymer electrolyte 550. There are conventional current collectors 540 associated with each of the cathodes 530.

In one example, the nano structured block copolymer electrolyte is a polystyrene-polyethyleneoxide-polystyrene (PS-PEO-PS) triblock copolymer doped with a lithium salt. The PS-PEO-PS/salt mixture serves both as the solid electrolyte 550 and as structural support to the thin lithium foil; the PEO block provides ion conducting channels, and the PS block provides mechanical integrity. The PS-PEO-PS/salt mixture serves also to ensure that even if the lithium metal becomes unstable or melts, no catastrophic battery failure will occur.

The embodiment of the invention shown in FIG. 5 has some important advantages over previous Li-metal batteries. The absence of a current collector for the anode reduces the weight of the battery, thus increasing the energy density. The inventive design also eliminates a major safety risk associated with previous lithium metal or lithium alloy batteries. If the battery 500 overheats to a temperature where lithium foil 510 begins to become unstable or melt, unlike currently-used electrolytes, the surrounding nanostructured block copolymer electrolyte 550 remains stable and can encapsulate the lithium, thus preventing a runaway reaction and catastrophic failure.

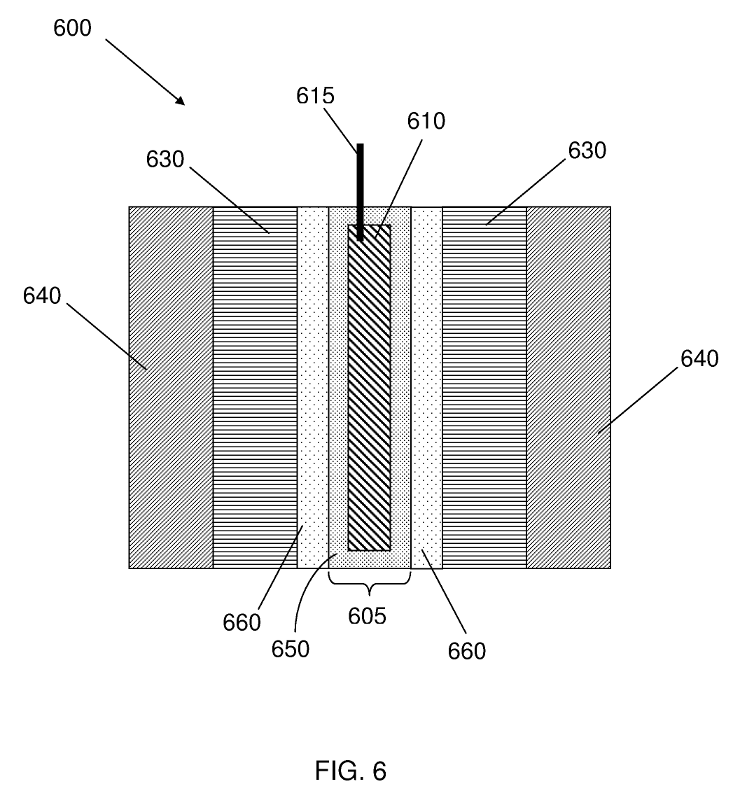

FIG. 6 is a schematic drawing that shows another new back-to-back lithium metal battery 600 according to an embodiment of the invention. The battery 600 has a lithium metal or metal alloy anode 610 that also serves as its own current collector and can make connections to a circuit (not shown) outside the battery through a lead 615. The lead 615 provides a path for electronic conduction between the anode 610 and an external circuit. In one arrangement, the anode 610 is a thin lithium or lithium alloy foil between about 10 and 60 μm thick. In another arrangement, the anode 610 is about 40 μm thick. In another arrangement, the anode 610 is between about 10 and 20 μm thick. The anode 610 may not have sufficient mechanical strength to undergo processing to make the battery 600. The anode 610 is enclosed within a nanostructured block copolymer electrolyte 650 to create an anode assembly 605. Once the lithium foil 610 is enclosed within the nanostructured block copolymer electrolyte 650, it is easier to handle and can undergo processing. There is a second polymer electrolyte 660 adjacent each side of the anode assembly 605. In one example, polysiloxane is used as the second polymer electrolyte 660. There are conventional cathodes 630 on each side of the second polymer electrolyte 660. There are conventional current collectors 640 associated with each of the cathodes 630.

In one example, the nano structured block copolymer electrolyte is a polystyrene-polyethyleneoxide-polystyrene (PS-PEO-PS) triblock copolymer doped with a lithium salt. The PS-PEO-PS/salt mixture serves both as the solid electrolyte 650 and as structural support to the thin lithium foil; the PEO block provides ion conducting channels, and the PS block provides mechanical integrity. The PS-PEO-PS/salt mixture serves also to ensure that even if the lithium metal becomes unstable or melts, no catastrophic battery failure will occur.

The second electrolyte layer 660 can be a very useful feature. Polymers that work well to perform useful structural, conductive, and safety functions for the lithium metal anode 610, such as nanostructured block copolymer electrolyte 650, may not be optimized to interact with cathode 630. Multi-layered 650, 660 polymer electrolytes, optimized for specific roles within the battery, can be employed easily in the present inventive design, as virtually all polymers are sparingly soluble in one another. In one arrangement, the polymer electrolyte 650 is optimized to support and to stabilize the anode 610 and the second electrolyte layer 660 is a polymer optimized to interact with the cathode 630, that is, both to be incorporated into the cathode and to provide ionic conduction between the polymer electrolyte 650 and the cathode 630. In another arrangement, the cathode 630 incorporates a different polymer material than either the polymer electrolyte 650 or the second electrolyte layer 660.

When only liquid electrolytes are used in a battery, it is not possible to use multi-layered electrolytes because most electrolyte liquids are miscible in one another and the liquid layers would mix together. In one embodiment of the present invention, a separator and a liquid electrolyte that neither interacts with nor is miscible with the nanostructured block copolymer electrolyte 650 can be used for both the second electrolyte layer 660 (with a separator) and for permeating the cathode 630. There is a conventional current collector 640 associated with the cathode 630.

### Nanostructured Block Copolymer Electrolytes

As described in detail above, a block copolymer electrolyte can be used in the embodiments of the invention.

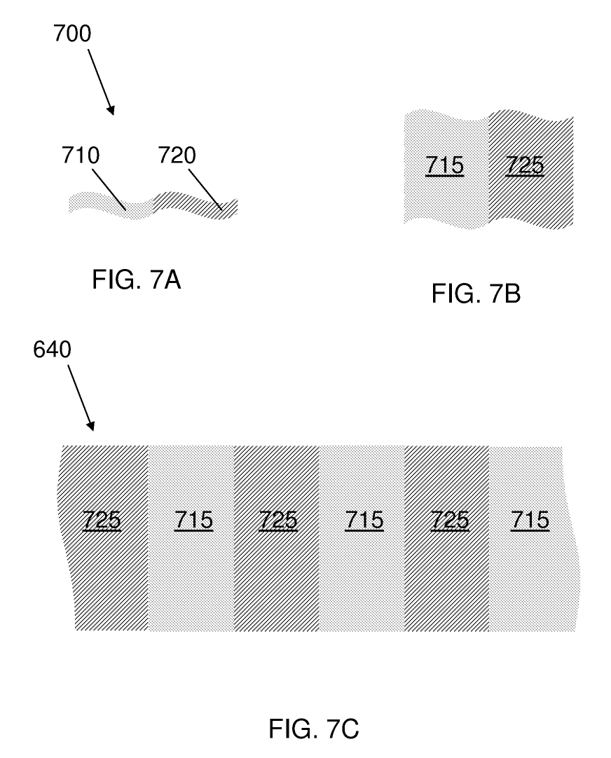

FIG. 7A is a simplified illustration of an exemplary diblock polymer molecule 700 that has a first polymer block 710 and a second polymer block 720 covalently bonded together. In one arrangement both the first polymer block 710 and the second polymer block 720 are linear polymer blocks. In another arrangement, either one or both polymer blocks 710, 720 has a comb structure. In one arrangement, neither polymer block is cross-linked. In another arrangement, one polymer block is cross-linked. In yet another arrangement, both polymer blocks are cross-linked.

Multiple diblock polymer molecules 700 can arrange themselves to form a first domain 715 of a first phase made of the first polymer blocks 710 and a second domain 725 of a second phase made of the second polymer blocks 720, as shown in FIG. 7B. Diblock polymer molecules 700 can arrange themselves to form multiple repeat domains, thereby forming a continuous nanostructured block copolymer material 740, as shown in FIG. 7C. The sizes or widths of the domains can be adjusted by adjusting the molecular weights of each of the polymer blocks.

In one arrangement the first polymer domain 715 is ionically conductive, and the second polymer domain 725 provides mechanical strength to the nanostructured block copolymer.

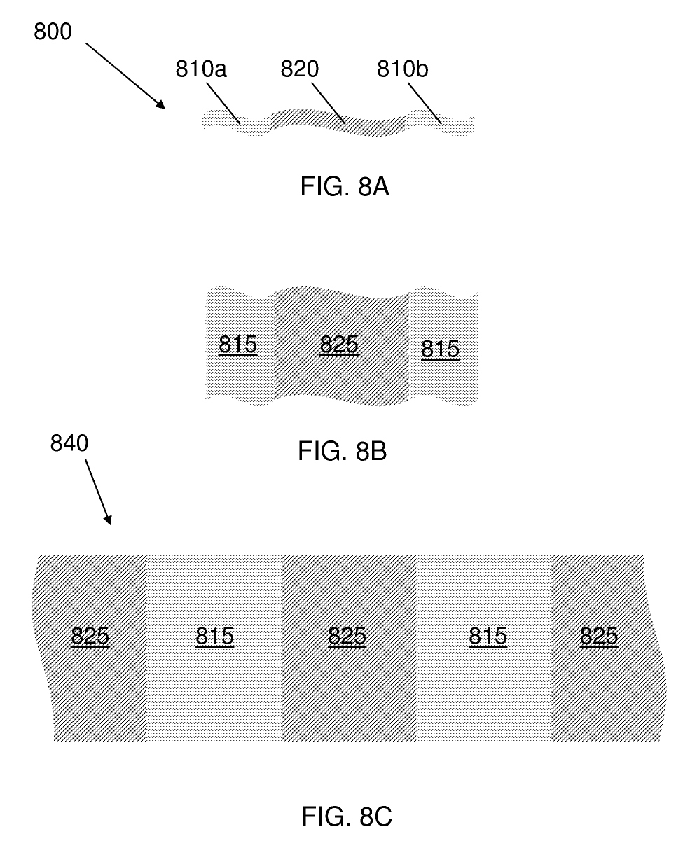

FIG. 8A is a simplified illustration of an exemplary triblock polymer molecule 800 that has a first polymer block 810a, a second polymer block 820, and a third polymer block 810b that is the same as the first polymer block 810a, all covalently bonded together. In one arrangement the first polymer block 810a, the second polymer block 820, and the third copolymer block 810b are linear polymer blocks. In another arrangement, either some or all polymer blocks 810a, 820, 810b have a comb structure. In one arrangement, no polymer block is cross-linked. In another arrangement, one polymer block is cross-linked. In yet another arrangement, two polymer blocks are cross-linked. In yet another arrangement, all polymer blocks are cross-linked.

Multiple triblock polymer molecules 800 can arrange themselves to form a first domain 815 of a first phase made of the first polymer blocks 810a, a second domain 825 of a second phase made of the second polymer blocks 820, and a third domain 815b of a first phase made of the third polymer blocks 810b as shown in FIG. 8B. Triblock polymer molecules 800 can arrange themselves to form multiple repeat domains 425, 415 (containing both 415a and 415b), thereby forming a continuous nanostructured block copolymer 830, as shown in FIG. 8C. The sizes of the domains can be adjusted by adjusting the molecular weights of each of the polymer blocks.

In one arrangement the first and third polymer domains 815a, 815b are ionically conductive, and the second polymer domain 825 provides mechanical strength to the nanostructured block copolymer. In another arrangement, the second polymer domain 825 is ionically conductive, and the first and third polymer domains 815 provide a structural framework.

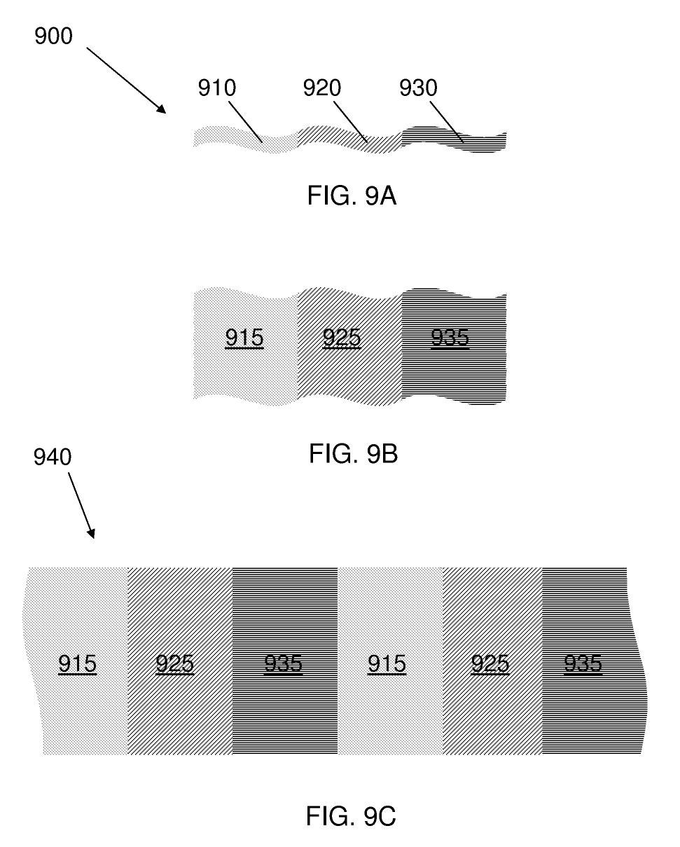

FIG. 9A is a simplified illustration of another exemplary triblock polymer molecule 900 that has a first polymer block 910, a second polymer block 920, and a third polymer block 930, different from either of the other two polymer blocks, all covalently bonded together. In one arrangement the first polymer block 910, the second polymer block 920, and the third copolymer block 930 are linear polymer blocks. In another arrangement, either some or all polymer blocks 910, 920, 930 have a comb structure. In one arrangement, no polymer block is cross-linked. In another arrangement, one polymer block is cross-linked. In yet another arrangement, two polymer blocks are cross-linked. In yet another arrangement, all polymer blocks are cross-linked.

Multiple triblock polymer molecules 900 can arrange themselves to form a first domain 915 of a first phase made of the first polymer blocks 910a, a second domain 925 of a second phase made of the second polymer blocks 920, and a third domain 935 of a third phase made of the third polymer blocks 930 as shown in FIG. 9B. Triblock polymer molecules 900 can arrange themselves to form multiple repeat domains, thereby forming a continuous nanostructured block copolymer 940, as shown in FIG. 9C. The sizes of the domains can be adjusted by adjusting the molecular weights of each of the polymer blocks.

In one arrangement the first polymer domains 915 are ionically conductive, and the second polymer domains 925 provide mechanical strength to the nanostructured block copolymer. The third polymer domains 935 provides an additional functionality that may improve mechanical strength, ionic conductivity, chemical or electrochemical stability, may make the material easier to process, or may provide some other desirable property to the block copolymer. In other arrangements, the individual domains can exchange roles.

Choosing appropriate polymers for the block copolymers described above is important in order to achieve desired electrolyte properties. In one embodiment, the conductive polymer (1) exhibits ionic conductivity of at least 10⁻⁵ Scm⁻¹ at electrochemical cell operating temperatures when combined with an appropriate salt(s), such as lithium salt(s); (2) is chemically stable against such salt(s); and (3) is thermally stable at electrochemical cell operating temperatures. In one embodiment, the structural material has a modulus in excess of 1×10⁵ Pa at electrochemical cell operating temperatures. In one embodiment, the third polymer (1) is rubbery; and (2) has a glass transition temperature lower than operating and processing temperatures. It is useful if all materials are mutually immiscible.

In one embodiment of the invention, the conductive phase can be made of a linear polymer. Conductive linear polymers that can be used in the conductive phase include, but are not limited to, polyethers, polyamines, polyimides, polyamides, alkyl carbonates, polynitriles, and combinations thereof. The conductive linear polymers can also be used in combination with polysiloxanes, polyphosphazines, polyolefins, and/or polydienes to form the conductive phase.

In another exemplary embodiment, the conductive phase is made of comb polymers that have a backbone and pendant groups. Backbones that can be used in these polymers include, but are not limited to, polysiloxanes, polyphosphazines, polyethers, polydienes, polyolefins, polyacrylates, polymethacrylates, and combinations thereof. Pendants that can be used include, but are not limited to, oligoethers, substituted oligoethers, nitrile groups, sulfones, thiols, polyethers, polyamines, polyimides, polyamides, alkyl carbonates, polynitriles, other polar groups, and combinations thereof.

Further details about polymers that can be used in the conductive phase can be found in U.S. Provisional Patent Application No. 61/056,688, filed May 28, 2008, U.S. Provisional Patent Application No. 61/091,626, filed Aug. 25, 2008, U.S. Provisional Patent Application No. 61/145,518 filed Jan. 16, 2009, U.S. Provisional Patent Application No. 61/145,507, filed Jan. 16, 2009, U.S. Provisional Patent Application No. 61/158,257 filed Mar. 6, 2009, and U.S. Provisional Patent Application No. 61/158,241, filed Mar. 6, 2009, all of which are included by reference herein.

There are no particular restrictions on the electrolyte salt that can be used in the block copolymer electrolytes. Any electrolyte salt that includes the ion identified as the most desirable charge carrier for the application can be used. It is especially useful to use electrolyte salts that have a large dissociation constant within the polymer electrolyte.

Suitable examples include alkali metal salts, such as Li salts. Examples of useful Li salts include, but are not limited to LiPF₆, LiN(CF₃SO₂)₂, Li(CF₃SO₂)₃C, LiN(SO₂CF₂CF₃)₂, LiB(C₂O₄)₂, B₁₂FₓH₁₂₋ₓ, B₁₂F₁₂, and mixtures thereof.

In one embodiment of the invention, single ion conductors can be used with electrolyte salts or instead of electrolyte salts. Examples of single ion conductors include, but are not limited to sulfonamide salts, boron based salts, and sulfates groups.

In one embodiment of the invention, the structural phase can be made of polymers such as polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, such as polyvinylidene fluoride, or copolymers that contain styrene, methacrylate, or vinylpyridine.

Additional species can be added to nanostructured block copolymer electrolytes to enhance the ionic conductivity, to enhance the mechanical properties, or to enhance any other properties that may be desirable.

The ionic conductivity of nanostructured block copolymer electrolyte materials can be improved by including one or more additives in the ionically conductive phase. An additive can improve ionic conductivity by lowering the degree of crystallinity, lowering the melting temperature, lowering the glass transition temperature, increasing chain mobility, or any combination of these. A high dielectric additive can aid dissociation of the salt, increasing the number of Li+ ions available for ion transport, and reducing the bulky Li+[salt] complexes. Additives that weaken the interaction between Li+ and PEO chains/anions, thereby making it easier for Li+ ions to diffuse, may be included in the conductive phase. The additives that enhance ionic conductivity can be broadly classified in the following categories: low molecular weight conductive polymers, ceramic particles, room temp ionic liquids (RTILs), high dielectric organic plasticizers, and Lewis acids.

Other additives can be used in the polymer electrolytes described herein. For example, additives that help with overcharge protection, provide stable SEI (solid electrolyte interface) layers, and/or improve electrochemical stability can be used. Such additives are well known to people with ordinary skill in the art. Additives that make the polymers easier to process, such as plasticizers, can also be used.

Further details about block copolymer electrolytes are described in U.S. patent application Ser. No. 12/225,934, filed Oct. 1, 2008, U.S. patent application Ser. No. 12/271,1828, filed Nov. 14, 2008, and PCT Patent Application Number PCT/US09/31356, filed Jan. 16, 2009, all of which are included by reference herein.

This invention has been described herein in considerable detail to provide those skilled in the art with information relevant to apply the novel principles and to construct and use such specialized components as are required. However, it is to be understood that the invention can be carried out by different equipment, materials and devices, and that various modifications, both as to the equipment and operating procedures, can be accomplished without departing from the scope of the invention itself.

1. An electrode assembly comprising:
a lithium metal or lithium-rich alloy anode layer enclosed within a first nano structured block copolymer electrolyte.

2. The assembly of claim 1, further comprising a lead in electronic communication with the anode layer, wherein the lead provides an electronically conductive path between the anode layer and an external circuit.

3. The assembly of claim 1, further comprising inorganic salts adjacent the anode layer.

4. The assembly of claim 1 wherein the first nanostructured block copolymer electrolyte comprises either a diblock or a triblock copolymer.

5. The assembly of claim 3 wherein a first block of the block copolymer is ionically conductive and is selected from the group consisting of polyethers, polyamines, polyimides, polyamides, alkyl carbonates, polynitriles, polysiloxanes, polyphosphazines, polyolefins, polydienes, and combinations thereof.

6. The assembly of claim 3 wherein a first block of the block copolymer comprises an ionically-conductive comb polymer, which comb polymer comprises a backbone and pendant groups.

7. The assembly of claim 6 wherein the backbone comprises one or more selected from the group consisting of polysiloxanes, polyphosphazines, polyethers, polydienes, polyolefins, polyacrylates, polymethacrylates, and combinations thereof.

8. The assembly of claim 6 wherein the pendants comprise one or more selected from the group consisting of oligoethers, substituted oligoethers, nitrile groups, sulfones, thiols, polyethers, polyamines, polyimides, polyamides, alkyl carbonates, polynitriles, other polar groups, and combinations thereof.

9. The assembly of claim 4 wherein the first block further comprises at least one lithium salt.

10. The assembly of claim 4 wherein a second block of the block copolymer is selected from the group consisting of polystyrene, polymethacrylate, poly(methyl methacrylate), polyvinylpyridine, polyvinylcyclohexane, polyimide, polyamide, polypropylene, polyolefins, poly(t-butyl vinyl ether), poly(cyclohexyl methacrylate), poly(cyclohexyl vinyl ether), poly(t-butyl vinyl ether), polyethylene, fluorocarbons, polyvinylidene fluoride, and copolymers that contain styrene, methacrylate, and/or vinylpyridine.

11. A battery cell comprising:
a lithium metal or lithium-rich alloy anode layer enclosed within a first nano structured block copolymer electrolyte; and
a cathode layer in ionic communication with a first side of the first nanostructured block copolymer electrolyte.

12. The cell of claim 11, further comprising a first current collector layer in electronic communication with the cathode layer.

13. The battery cell of claim 11 further comprising a lead in electronic communication with the anode layer, wherein the lead provides an electronically conductive path between the anode layer and an external circuit.

14. The battery cell of claim 11 wherein the lithium-rich alloy anode layer comprises an alloy selected from the group consisting of Li—Al, Li—Si, Li—Sn, Li—Hg, Li—Zn, Li—Pb, and Li—C.

15. The assembly of claim 11, further comprising inorganic salts adjacent the anode layer.

16. The battery cell of claim 11 further comprising a second electrolyte layer between the first nanostructured block copolymer electrolyte and the cathode.

17. The battery cell of claim 16 wherein the second electrolyte layer comprises a second nanostructured block copolymer electrolyte.

18. The battery cell of claim 16 wherein the second electrolyte layer comprises a separator and a liquid electrolyte, the liquid electrolyte immiscible with the first nanostructured block copolymer electrolyte.

19. A battery cell comprising:
a lithium metal or lithium-rich alloy anode layer enclosed within a first nanostructured block copolymer electrolyte;
a first cathode in ionic communication with a first side of the first nanostructured block copolymer electrolyte;
a first current collector in electronic communication with the first cathode;
a second cathode in ionic communication with a second side of the first nanostructured block copolymer electrolyte, the second side opposite the first side; and
a second current collector in electronic communication with the second cathode.

20. The battery cell of claim 19 further comprising a lead in electronic communication with the anode layer, wherein the lead provides an electronically conductive path between the anode layer and an external circuit.

21. The battery cell of claim 19 further comprising inorganic salts adjacent the anode layer.

22. The battery cell of claim 19 further comprising a second electrolyte layer between the first nanostructured block copolymer electrolyte and the first cathode and between the first nanostructured block copolymer electrolyte and the second cathode.

23. The battery cell of claim 19 wherein the second electrolyte layers comprise a second nanostructured block copolymer electrolyte.

24. The battery cell of claim 19 wherein at least one of the second electrolyte layers comprises a separator and a liquid electrolyte, the liquid electrolyte immiscible with the first nanostructured block copolymer electrolyte.

25. A method of making an anode assembly, comprising the steps of:
providing a lithium or lithium-rich alloy foil; and
coating the foil with a block copolymer electrolyte.

26. The method of claim 25, further comprising the step of applying inorganic salts to the foil before the coating step.

27. The method of claim 25 wherein the coating step comprises:
applying a solution of the block copolymer electrolyte to a set of rollers; and
running the foil through the rollers.

28. The method of claim 25 wherein the coating step comprises:
applying a static charge to the foil;
spray-coating particles of block copolymer electrolyte onto the foil; and
annealing the particles onto the foil.

29. The method of claim 25 wherein the coating step comprises:
providing an extruder;
preparing two layers of block copolymer electrolyte;
positioning a layer of the foil between the two layers of block copolymer electrolyte; and
feeding the layers into the extruder.
